(19) United States
(12) Patent Application Publication
(10) Pub. No.: US 2011/0070467 A1
(43) Pub. Date: Mar. 24, 2011

(54) Battery with a plurality of flat cells forming a cell assembly

(75) Inventors: Jens Meintschel, Bernsdorf (DE); Dirk Schroeter, Winnenden (DE)

(73) Assignee: Daimler AG, Stuttgart (DE)

(21) Appl. No.: 12/918,908

(22) PCT Filed: Feb. 19, 2009
(86) PCT No.: PCT/EP2009/001176

§ 371 Date: Nov. 30, 2010

(30) Foreign Application Priority Data
Feb. 23, 2008 (DE) 10 2008 010 823.5

(51) Int. Cl. H01M 10/42

(52) U.S. Cl. 429/7

(57) ABSTRACT

The invention relates to a battery (B) with a plurality of flat cells (1) forming a cell assembly (Z) that are arranged one after the other and are electrically interconnected in series and/or in parallel, wherein at least one electrical component is integrated into the cell assembly (Z), in that it is arranged at least partially between two flat cells (1) of the cell assembly (Z) or at one end of the cell assembly (Z) and is connected to the cell assembly (Z) in a form-fit or force-fit manner.

The invention relates to a battery with a plurality of flat cells forming a cell assembly which are arranged one after the other and are electrically interconnected with each other in series and/or in parallel and form a cell assembly.

A battery with a plurality of individual cells is known, whose pole contacts are electrically interconnected with each other in parallel and in series and which form a cell assembly

With these batteries, electrical components such as the contactor and the fuse are fastened to the contacts of the cell block by means of current bars or cables. These components are e.g. fastened mechanically to the housing.

The invention is based on the object to give a battery with a constructional width which is as small as possible.

The object is solved according to the invention by an arrangement which has the characteristics given in claim 1.

Advantageous arrangements of the invention are the subject of the dependent claims.

The battery according to the invention consists of a plurality of flat cells forming a cell assembly, which are arranged one after the other and which are electrically interconnected in series and/or in parallel. It is distinguished in that at least one electrical component is integrated into the cell assembly, in that it is arranged at least partially between two flat cells of the cell assembly or at one end of the cell assembly and is connected to the cell assembly, particularly in a form-fit and/or force-fit manner.

An electrical component integrated into the cell assembly is thereby for example an electrical safety element for protecting the battery from an electrical overcurrent and/or an electrical short circuit. The electrical safety element thereby preferably has an electrical safety fuse and two electrical contacts, which are electrically connected to respectively one flat cell.

In an advantageous arrangement of the battery according to the invention, the two electrical contacts of the electrical safety element are formed as two electrically conductive contact plates, and which are insulated with regard to each other, which are arranged between two flat cells of the cell assembly, for example centrally within the cell assembly, wherein each of the two contact plates is connected to a flat cell abutting this in a force-fit manner.

The electrical safety fuse is thereby arranged outside the cell assembly or alternatively between the two contact plates.

As a further or alternative electrical component integrated into the cell assembly is provided a contactor element, which comprises a contactor for the electrical connection of the battery to an electrical current circuit and is for example arranged an one end of the cell assembly.

The contactor element further preferably comprises a first pressure plate, whose outer dimensions largely correspond to the outer dimensions of a flat cell. The cell assembly is thereby arranged between this first pressure plate and a second pressure plate in a force-fit manner, whose outer dimensions also largely correspond to the outer dimensions of a flat cell.

The force closure between the cell assembly and the two pressure plates is thereby is thereby preferably produced by at least one clamping element, which is guided around the cell assembly and the two pressure plates and presses these together. A suitable clamping element is for example a clamping strap or a clamping frame.

An advantageous arrangement of the invention further provides that the pressure plates are formed in a metallic manner and are connected to a flat cell on the cell assembly side in an electrically conductive manner. They can thereby simultaneously be used as electrical contacts of the cell assembly in addition to their press-on function.

In a particularly advantageous arrangement of the battery according to the invention, the contactor element is formed as a flat contactor, whose outer dimensions correspond to the outer dimensions of a flat cell. The flat contactor thereby has an electrically conductive outer surface, via which it is connected to a flat cell in an electrically conductive manner. The flat contactor can alternatively have contact elements, via which it can be contacted in an electrical manner from the outside of the cell assembly and in particular with the cell assembly.

The flat contactor can further have a thermal overload protection, which effects a switching off of the battery by the flat contactor when a temperature threshold is exceeded. This is in particular advantageous as the flat contactor has a close thermal contact with a flat cell, which permits to detect an overheating of the flat cell without external input of a temperature signal.

The battery can further have several flat contactors. A flat contactor can for example respectively be arranged at the two ends of the cell assembly. By means of such an arrangement of the contactors directly at the poles of the cell assembly, it is avoided in a safe manner that the two poles of the cell assembly can come into contact with the contactors via their connection. The safety of the battery is increased thereby.

A further flat contactor can furthermore be arranged between two flat cells in the interior of the cell assembly. Partial regions of the battery can thereby also be switched off or on.

A flat contactor arranged at one end of the cell assembly can further have a pressure plate surface at its side facing away from the cell assembly, via which plate the flat contactor can be pressed to the cell assembly. The first pressure plate described above can thereby be omitted, so that the construction of the battery is simplified further.

In summary, the integration of at least one electrical component in the cell assembly according to the invention has a number of advantages compared to conventional battery designs:
The constructional width of the battery can be reduced, as an electrical component in the cell assembly requires a smaller space according to the invention than with conventional designs.
The construction of the battery is simplified, whereby especially the assembly of the battery is eased.
The costs for the production and assembly of the battery are reduced.

Embodiments of the invention are explained in more detail in the following by means of drawings.

It shows thereby:

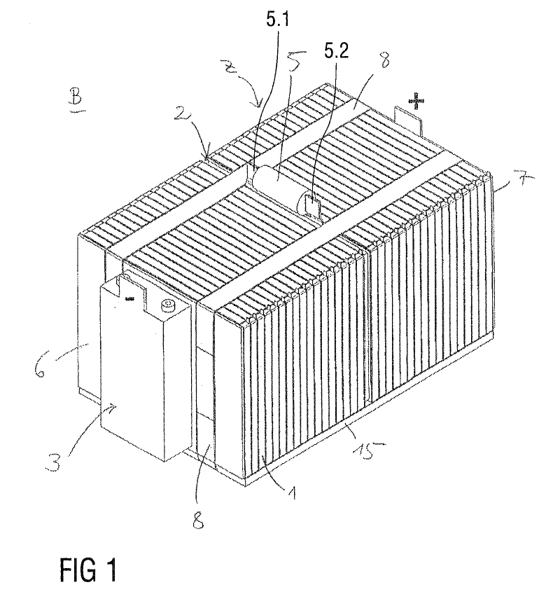

FIG. 1 a perspective depiction of a battery with a contactor element and an electrical safety element in a view from the contactor side,

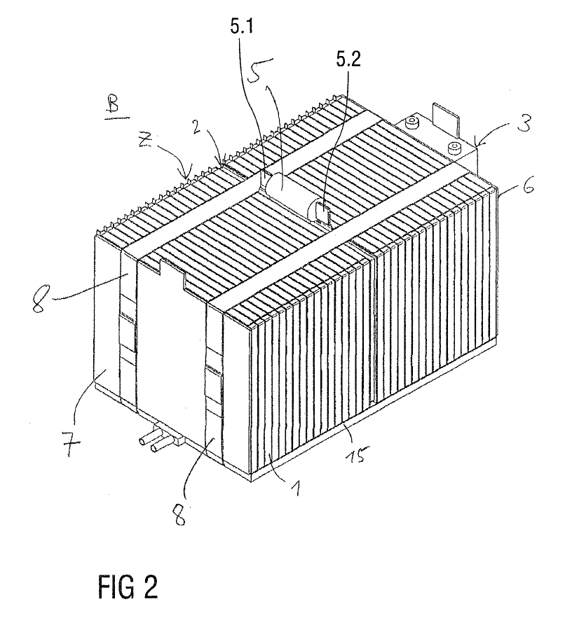

FIG. 2 a perspective depiction of a battery with a contactor element and an electrical safety element in a view from the side opposite the contactor side,

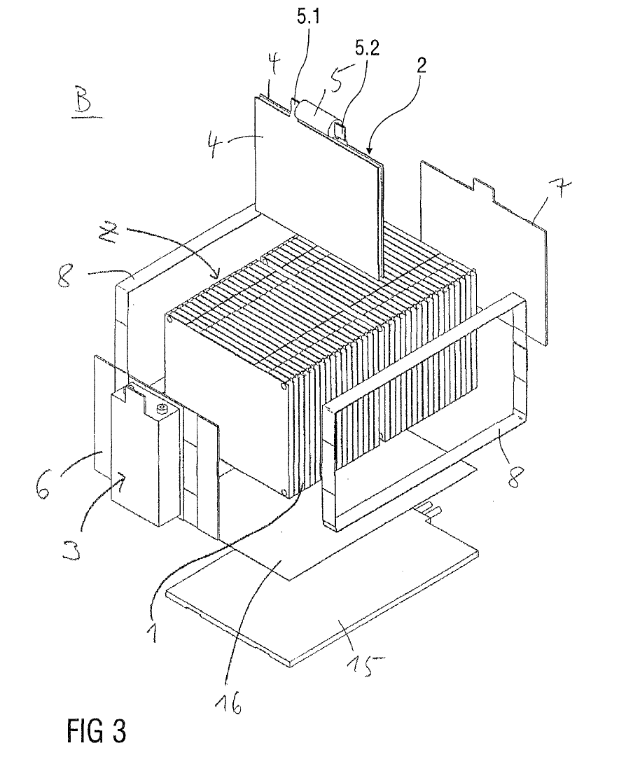

FIG. 3 a perspective exploded depiction of a battery with a contactor element and an electrical safety element in a view from the contactor side,

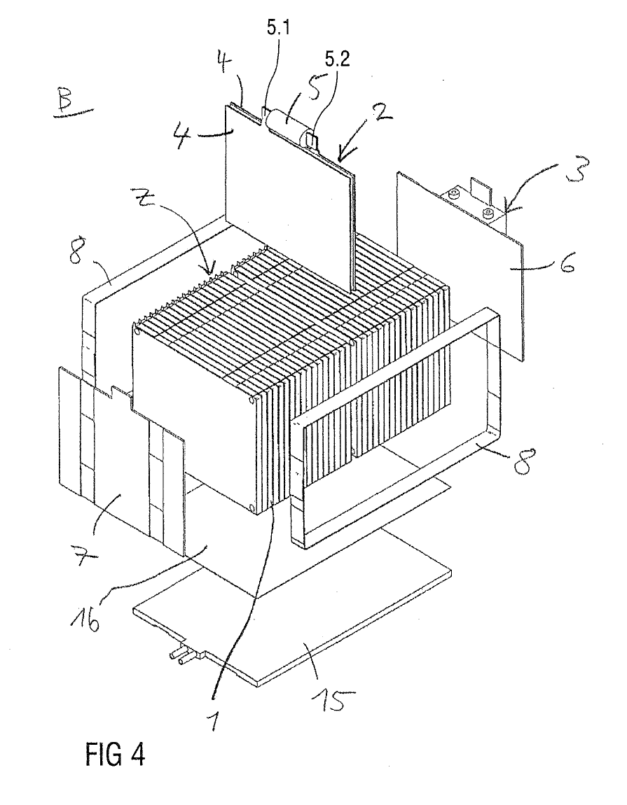

FIG. 4 a perspective exploded depiction of a battery with a contactor element and an electrical safety element in a view from the side opposite the contactor side,

FIG. 5 a perspective depiction of a safety element,

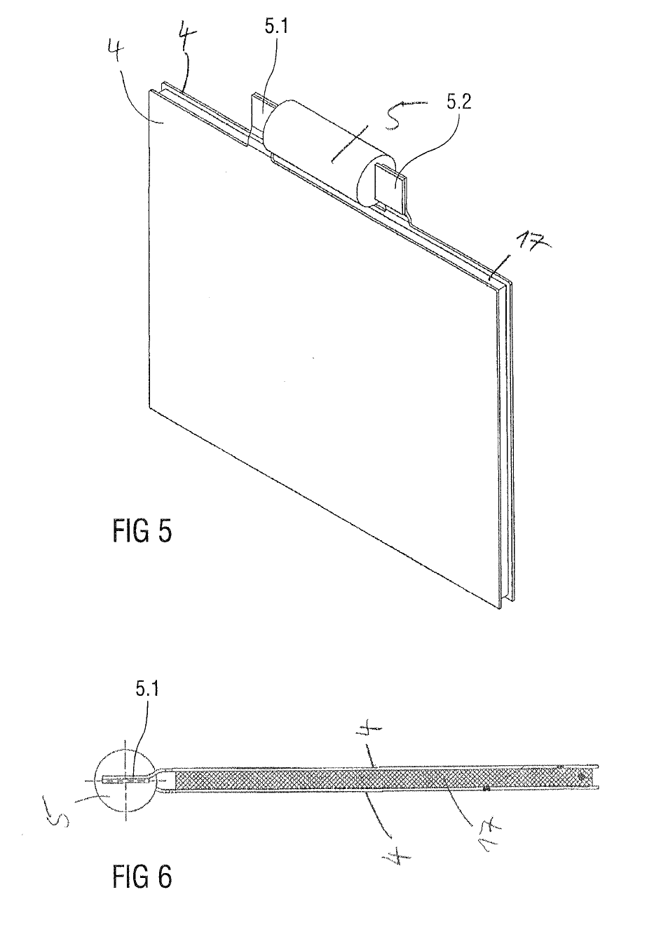

FIG. 6 a sectional depiction of a safety element from the side,

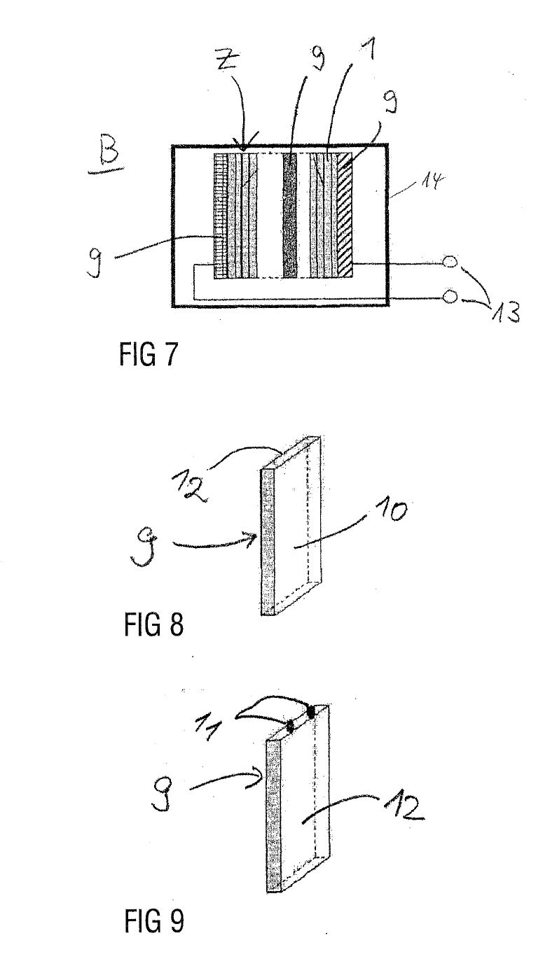

FIG. 7 schematically a longitudinal sectional depiction of a battery with three flat contactors,

FIG. 8 schematically a perspective depiction of a flat contactor with an electrically conductive outer surface, and

FIG. 9 schematically a perspective depiction of a flat contactor with contact elements.

Parts corresponding to each other are provided with the same reference numerals in all figures.

FIG. 1 and FIG. 2 show perspective depictions of a battery B according to the invention with several flat cells 1 forming a cell assembly Z in two different views. The flat cells are arranged one after the other in the manner of a stack.

The battery B has a contactor element 3 and an electrical safety element 2. The contactor element 3 is arranged at one end of the cell assembly Z. The electrical safety element 2 is arranged centrally in the cell assembly Z between two flat cells 1 in this embodiment. The battery further has a cooling plate 15, which is arranged at the bottom side of the cell assembly Z and which serves for the cooling of the battery B.

The contactor element 3 comprises a contactor, by means of which the battery B can be connected to an electrical current circuit. The contactor element 3 further comprises a first pressure plate 6, whose outer dimensions largely correspond to the outer dimensions of a flat cell 1. The outer dimensions of a flat cell 1 are thereby meant to be the dimensions of a vertical cross-sectional surface of the flat cell 1 in a plane vertical to the axial direction of the cell assembly Z. The corresponding is valid for the outer dimensions of the first pressure plate 6.

At the end of the cell assembly opposite the contactor element 3 is arranged a second pressure plate 7, whose outer dimensions also largely correspond to the outer dimensions of a flat cell 1. The battery B further has two clamping elements 8, which are designed as clamping straps and are respectively guided around the cell assembly 3, the two pressure plates 6 and 7, and the cooling plate 15. The pressure plates 6 and 7 are pressed to the cell assembly Z by means of the clamping elements 8 in a force-fit manner and simultaneously respective adjacent flat cells 1 are pressed to each other.

The contacting side surfaces of the flat cells 1, as known from the state of the art, are thereby designed in a metallic manner as electrical pole contacts of the flat cells 1 and are for example arranged in such a manner that the flat cells 1 are electrically interconnected with each other in series.

The pressure plates 6 and 7 are also designed in a metallic manner in an advantageous manner, so that they form electrical contacts of the cell assembly Z with a respective outer flat cell 1 of the cell assembly Z.

The electrical safety element 2 has an electrical safety fuse 5 designed in a conventional manner, which is arranged above the cell assembly Z due to reasons of installation space and which is connected to the two flat cells 1 enclosing the electrical safety element 2.

FIGS. 3 and 4 show perspective exploded depictions of the battery B shown in FIGS. 1 and 2. It is clear thereby that the electrical safety element 2 has two contact plates 4, which are respectively connected to the electrical safety fuse 5 and whose outer dimensions largely correspond to the outer dimensions of a flat cell 1.

The design of the electrical safety element 2 is clarified further in FIGS. 5 and 6. FIG. 5 thereby shows a perspective depiction and FIG. 6 a sectional depiction of the electrical safety element 2. The contact plates 4 are electrically insulated with regard to each other by an insulation layer 17 and are respectively connected to the electrical safety fuse 5 via a tab-like extension (5.1, 5.2)

FIG. 7 schematically shows a further embodiment of a battery B according to the invention with three contactor elements 3 respectively formed as a flat contactor 9. A flat contactor 9 is designated as a contactor which is close in its outer dimensions to the outer dimensions of a flat cell and whose depth is not considerably larger than the depth of a flat cell 1, for example at the most three times the depth of a flat cell 1. These flat contactors are adapted to the geometry of the cell assembly in a particular good manner and are thus particularly suitable for a reduction of the battery design.

The flat contactor 9 corresponds to known contactor designs in its internal construction with solenoids, electromagnets, movable bars and/or electronic switching elements such as transistors, for example bipolar transistors with insulated gate electrode (IGTB=insulated-gate bipolar transistor).

According to FIG. 7, a flat contactor is arranged at each end of to cell assembly Z. A further optional flat contactor 9 can be arranged between two flat cells 1 in the interior of the cell assembly Z, as shown.

The flat contactors 9 are guided to electrical connections 13 through a battery housing 14, via which connections they can be connected electrically to users.

FIG. 8 schematically shows a flat contactor 9 to an electrical contacting of a flat cell 1 via an electrically conductive outer surface 10.

FIG. 9 shows an alternative embodiment of a flat contactor 9 with electrical contacts 11 at a small outer side of the flat contactor 9, for example for contacting a flat cell 1 electrically insulated from the flat contactor 9.

The embodiments of a flat contactor 9 according to FIGS. 8 and 9 largely respectively provide that an outer side of the flat contactor 9 is formed as a pressure plate 12, via which the flat contactor 9 can be pressed to the cell assembly Z. This outer side of the flat contactor 9 is formed of a material which is suitable for the strength and hardness to be chosen. A flat contactor 9 formed in such a manner is provided for a positioning at one end of the cell assembly Z.

### LIST OF REFERENCE NUMERALS

1 Flat cell
2 Electrical safety element
3 Contactor element
4 Contact plates
5 Electrical safety fuse
5.1,5.2 Tab-like extension
6 First pressure plate
7 Second pressure plate
8 Clamping element
9 Flat contactor
10 Electrically conductive outer surface
11 Contact element
12 Pressure plate surface
13 Electrical connection
14 Battery housing
15 Cooling plate
16 Heat-conducting film
17 Insulation
B Battery
Z Cell assembly

1. Battery (B) with a plurality of flat cells (1) forming a cell assembly (Z) that are arranged one after the other and are electrically interconnected in series and/or in parallel,
characterized in that
at least one electrical component is integrated into the cell assembly (Z), in that it is arranged at least partially between two flat cells (1) of the cell assembly (Z) or at one end of the cell assembly (Z) and is connected to the cell assembly (Z), in particular in a form-fit or force-fit connection.

2. Battery (B) according to claim 1,
characterized in that
an electrical component integrated into the cell assembly (Z) is an electrical safety element (2) for protecting the battery (B) from electrical overcurrent and/or an electrical short circuit.

3. Battery (B) according to claim 1,
characterized in that
an electrical component integrated into the cell assembly (Z) is a contactor element (3) with a contactor for the electrical connection of the battery (B) to an electrical current circuit.

4. Battery (B) according to claim 2,
characterized in that
the electrical safety element (2) has two electrical contacts, which are electrically connected to respectively one flat cell (1).

5. Battery (B) according to claim 4,
characterized in that
the two electrical contacts are two electrically conductive contact plates (4) and which are insulated with regard to one another, which are arranged between two flat cells (1) of the cell assembly (Z), wherein each of the two contact plates (4) is connected to a flat cell (1) abutting this in a force-fit manner.

6. Battery (B) according to claim 5,
characterized in that
the contact plates (4) are arranged centrally in the cell assembly (Z).

7. Battery (B) according to claim 5,
characterized in that
the electrical safety element (2) is an electrical safety fuse (5).

8. Battery (B) according to claim 6,
characterized in that
the electrical safety fuse (5) is arranged outside the cell assembly (Z).

9. Battery (B) according to claim 6,
characterized in that
the electrical safety fuse (5) is arranged within the cell assembly (Z) between the two contact plate (4).

10. Battery (B) according to claim 3,
characterized in that
the contactor element (3) is arranged at one end of the cell assembly (Z).

11. Battery (B) according to claim 10,
characterized in that
the contactor element (3) comprises a first pressure plate (6), whose outer dimensions largely correspond to the outer dimensions of a flat cell (1).

12. Battery (B) according to claim 11,
characterized in that
the cell assembly (Z) is connected in a force-fit manner between the first pressure plate (6) and a second pressure plate (7), wherein the outer dimensions of the second pressure plate (7) largely correspond to the outer dimensions of a flat cell (1).

13. Battery (B) according to claim 12,
characterized in that
the battery (B) has at least one clamping element (8), which is guided around the cell assembly (Z) and the two pressure plates (6,7) and connects these in a force-fit manner.

14. Battery (B) according to claim 13,
characterized in that
at least one clamping element (8) is a clamping strap or a clamping frame.

15. Battery (B) according to claim 10,
characterized in that
the contactor element (3) is connected to a flat cell (1) on the cell assembly side in an electrically conductive manner.

16. Battery (B) according to claim 12,
characterized in that
the second pressure plate (7) consists of a metal and is connected to the cell assembly (Z) in an electrically conductive manner, so that it forms an electrical contact of the cell assembly (Z).

17. Battery (B) according to claim 3,
characterized in that
the contactor element (3) is formed as a flat contactor (9), whose outer dimensions correspond to the outer dimensions of a flat cell (1).

18. Battery (B) according to claim 17,
characterized in that
the flat contactor (9) has an electrically conductive outer surface (10), via which it is connected to a flat cell (1) in an electrically conductive manner.

19. Battery (B) according to claim 17,
characterized in that
the flat contactor (9) has contact elements (11), via which it can be contacted electrically from the outside of the cell assembly (Z).

20. Battery (B) according to claim 17,
characterized in that
the flat contactor (9) has a thermal overload protection, which effects a switch-off of the of the battery (B) by the flat contactor (9) when exceeding a temperature threshold.

21. Battery (B) according to claim 17,
characterized in that
a flat contactor (9) is respectively arranged at both ends of the cell assembly (Z).

22. Battery (B) according to claim 21,
characterized in that
a flat contactor (9) is arranged between two flat cells (1) in the interior of the cell assembly (Z).

23. Battery (B) according to claim 17,
characterized in that
a flat contactor (9) arranged at one end of the cell assembly (Z) has a pressure plate surface (12) at its side facing away from the cell assembly (Z), via which plate the flat contactor (9) can be pressed to the cell assembly (Z).
